(19) United States
(12) Patent Application Publication
(10) Pub. No.: US 2011/0102386 A1
(43) Pub. Date: May 5, 2011

(54) INFORMATION PROCESSING APPARATUS AND DISPLAY CONTROL METHOD

(75) Inventor: Masaya SAHASHI, Ome-shi (JP)

(73) Assignee: KABUSHIKI KAISHA TOSHIBA, Tokyo (JP)

(21) Appl. No.: 12/906,867

(22) Filed: Oct. 18, 2010

(30) Foreign Application Priority Data
Oct. 30, 2009 (JP) 2009-251284

(51) Int. Cl. G09G 5/00; G06F 3/00

(52) U.S. Cl. 345/204; 715/795

(57) ABSTRACT

According to one embodiment, an information processing apparatus is configured to display a plurality of windows on a display. The information processing apparatus specifies an active window of windows displayed on the display, when a notice indicating that a new window is to be displayed on the display is received, and determines whether an application corresponding to the active window is being used or not, based on a first operation definition information item associated with the application corresponding to the active window. The information processing apparatus display the new window on a background of the active window as a window with a lower priority than the active window, when it is determined that the application corresponding to the active window is being used.

### CROSS-REFERENCE TO RELATED APPLICATIONS

This application is based upon and claims the benefit of priority from Japanese Patent Application No. 2009-251284, filed Oct. 30, 2009; the entire contents of which are incorporated herein by reference.

### FIELD

Embodiments described herein relate generally to an information processing apparatus which executes display control of a plurality of windows, and a display control method which is applied to this apparatus.

### BACKGROUND

In general, when an application is executed on an information processing apparatus such as a personal computer, the information of the application is displayed in the form of a window. In this case, the displayed window may be set in a state in which the window is focused as an active window, that is, in a state in which the window is selected as a foreground window. When a new window is opened in such a state that a certain window is active, that is, a certain window is focused, the new window, in some cases, is displayed on top of the above-described focused window. In this case, focus is transferred to the new window, that is, the new window becomes active. As a result, the user, who views and uses the focused window of the application, can no longer perform the manipulation on this window. If a new window is displayed in an overlapping manner over the focused window, the focused window is hidden by the new window. To cope with this, Jpn. Pat. Appln. KOKAI Publication No. H10-11258, for instance, discloses a technique wherein when a new window is opened, it is determined whether a currently focused window is being used by a user, and if it is determined that the focused window is in use, the new window is opened so as not to transfer focus from the focused window.

In the technique of KOKAI Publication No. H10-11258, however, whether the currently focused window is being used by the user or not is always determined under the same condition, regardless of an application corresponding to this focused window. In other words, the determination as to whether the window is in use or not is executed according to a preset condition, with no consideration given to what kind of application the currently focused window (active window) is associated with. Thus, although a window is being used by a user, this window may possibly be determined to be not in use by the user. For example, it is highly possibly that this situation applies to a window corresponding to an application such as video playback software, which is not manipulated by the user for a long time.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing an external appearance of an information processing apparatus according to an embodiment;

FIG. 2 is an exemplary block diagram showing the structure of the information processing apparatus of the embodiment;

FIG. 3 is an exemplary block diagram showing the functional structure of a display control application which is executed by the information processing apparatus of the embodiment;

FIG. 4 is an exemplary flow chart illustrating the operation of the display control application which is executed by the information processing apparatus of the embodiment;

FIG. 5 is an exemplary view schematically showing a task table which is referred to by the display control application which is executed by the information processing apparatus of the embodiment;

FIG. 6 is an exemplary flow chart illustrating the operation of the display control application which is executed by the information processing apparatus of the embodiment;

FIG. 7 is an exemplary view schematically showing operation definition information which is referred to by the display control application which is executed by the information processing apparatus of the embodiment;

FIG. 8 is an exemplary view schematically showing an active window which is determined by the display control application which is executed by the information processing apparatus of the embodiment;

FIG. 9 is an exemplary view schematically showing a display mode of an active window and a new window, which is controlled by the display control application which is executed by the information processing apparatus of the embodiment; and

FIG. 10 is an exemplary view showing a display mode of an active window and a new window, which is controlled by the display control application which is executed by the information processing apparatus of the embodiment.

### DETAILED DESCRIPTION

Various embodiments will be described hereinafter with reference to the accompanying drawings.

In general, according to one embodiment, an information processing apparatus is configured to display a plurality of windows on a display. The information processing apparatus comprises a storage device, a determining module and a control module. The storage device is configured to store a plurality of operation definition information items corresponding to applications which are executed on the information processing apparatus. The determining module is configured to specify an active window of windows displayed on the display, when a notice indicating that a new window is to be displayed on the display is received, and is configured to determine whether an application corresponding to the active window is being used or not, based on a first operation definition information item of the plurality of operation definition information items. The first operation definition information item is associated with the application corresponding to the active window. The control module is configured to display, when it is determined that the application corresponding to the active window is being used, the new window on a background of the active window as a window with a lower priority than the active window.

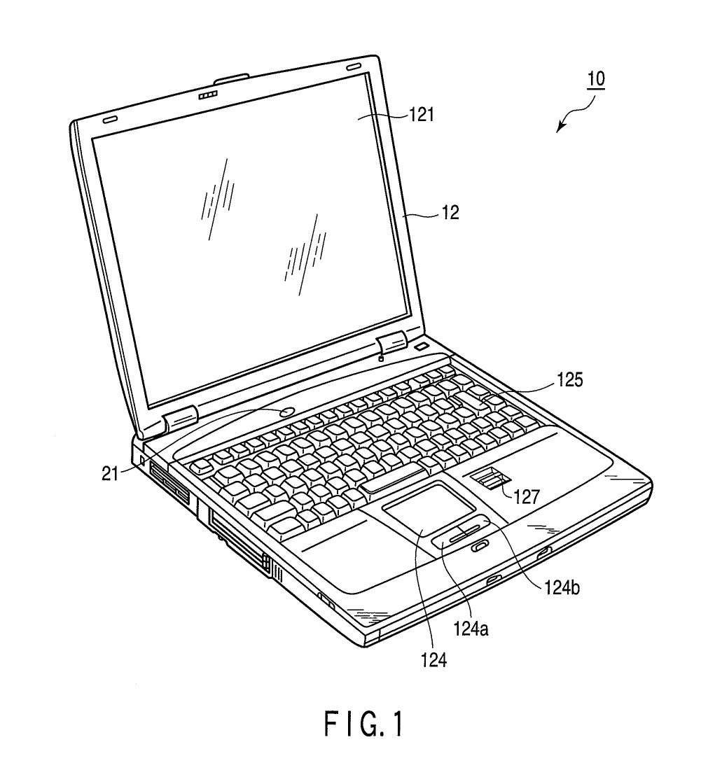

To begin with, referring to FIG. 1, the structure of an information processing apparatus according to an embodiment is described. The information processing apparatus of the embodiment is realized, for example, as a notebook personal computer 10. Although in this embodiment the information processing apparatus is described as being the notebook personal computer 10, the information processing apparatus is not limited to the computer 10. The information processing apparatus may be any device having a display device, such as a PDA (Personal Digital Assistant).

As shown in FIG. 1, the computer 10 comprises a computer main body and a display unit 12. A display device, which is composed of an LCD (Liquid Crystal Display), is built in the display unit 12, and an LCD 121 that is the display screen of the display unit 12 is positioned at an approximately central part of the display unit 12.

The display unit 12 is attached to the computer 10 in a manner to be rotatable between an open position and a closed position. The main body of the computer 10 has a thin box-shaped housing. A power button 21 and a keyboard 125 are disposed on the top surface of the main body, and a touch pad 124 and left and right buttons 124a and 124b are disposed on the palm rest.

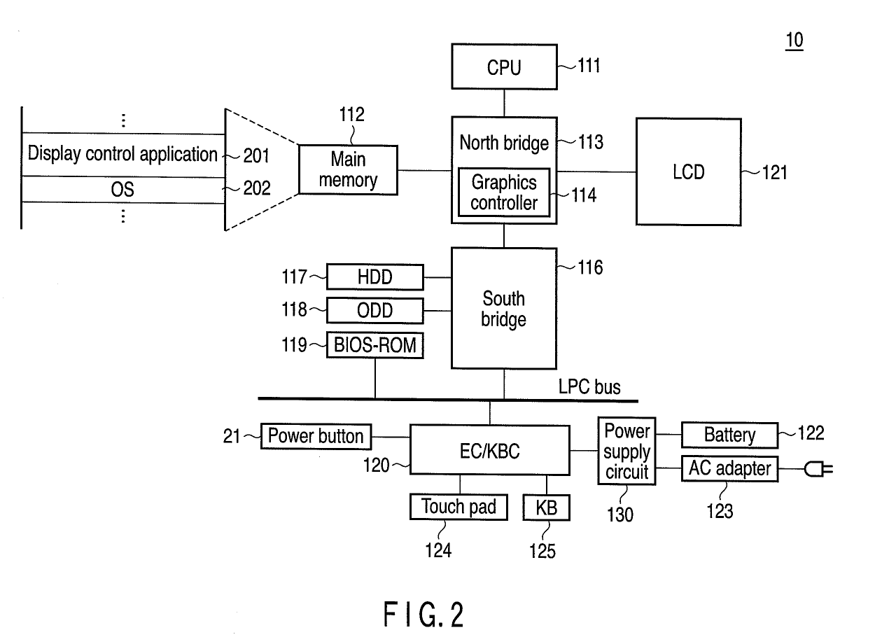

Next, referring to FIG. 2, the system configuration of the computer 10 is described.

The computer 10, as shown in FIG. 2, comprises a CPU 111, a north bridge 113, a graphics controller 114, a main memory 112, an LCD 121, a south bridge 116, a hard disk drive (HDD) 117, an optical disc drive (ODD) 118, a BIOS-ROM 119, an embedded controller/keyboard controller IC (EC/KBC) 120, a touch pad 124, a keyboard 125, a power supply circuit 130, a battery 122 and an AC adapter 123.

The CPU 111 is a processor which controls the operation of the computer 10. The CPU 111 executes an operating system (OS) 202 and various applications (application programs) such as a display control application program 201 (also referred to as “display control application”), which are loaded from the hard disk drive (HDD) 117 into the main memory 112. When the display control application program 201 receives a request to automatically open a new window on a desktop displayed on the LCD 121, the display control application program 201 determines whether an active window, which is currently opened on the desktop, is being used. The case of automatically open a new window refers to a case of automatically open a window, such as a pop-up window, regardless of a request by the user. If the display control application program 201 determines that the active window, which is currently opened on the desktop, is in use, the display control application program 201 executes control to keep the window, which is currently opened on the desktop, in the active state, without rendering active the new window which is opened on the desktop.

The north bridge 113 is a bridge device that connects a local bus of the CPU 111 and the south bridge 116. The north bridge 113 includes a memory controller which access-controls the main memory 112. The north bridge 113 has a function of communicating with the graphics controller 114.

The graphics controller 114 is a display controller which controls the LCD (display) 121 that is used as a display monitor of the computer 10. A display signal, which is generated by the graphics controller 114, is sent to the LCD 121 of the display unit 12. In addition, the graphics controller 114 may send to the CPU 111 the information of the application which is displayed on the desktop of the OS 202 displayed on the LCD 12. The information of the application may be, for example, the name of the application corresponding to an active (focused) window.

The CPU 111 sends the received information of the application to the display control application 201. Upon receiving the above-described request for automatically displaying a new window on the desktop, the display control application 201 executes the following control. Specifically, based on operation definition information (to be described later) corresponding to applications stored in the HDD 117 or the like, which is a storage module, the display control application 201 determines whether the application corresponding to an active window displayed on the desktop is being used by the user or not. If it is determined that this application is in use, the display control application 201 keeps active the window corresponding to the application, which is displayed on the desktop, and displays a new window on the desktop. Accordingly, the new window, which is displayed on the desktop, is not in an active state. Thus, the user can manipulate and view the application corresponding to the active window which is opened from the beginning. The new window refers to a window, such as a pop-up window, which is automatically opened regardless of the user's instruction.

The south bridge 116 controls the devices on an LPC (Low Pin Count) bus. In addition, the south bridge 116 includes an IDE (Integrated Drive Electronics) controller for controlling the hard disk drive (HDD) 117 and ODD 118. The south bridge 116 also includes a function of communicating with a sound controller.

The embedded controller/keyboard controller IC (EC/KBC) 120 is a one-chip microcomputer in which an embedded controller for power management and a keyboard controller for controlling the keyboard (KB) 125 and touch pad 124 are integrated. The embedded controller/keyboard controller IC (EC/KBC) 120 has a function of powering on/off the computer 10 in response to the user's operation of the power button 21.

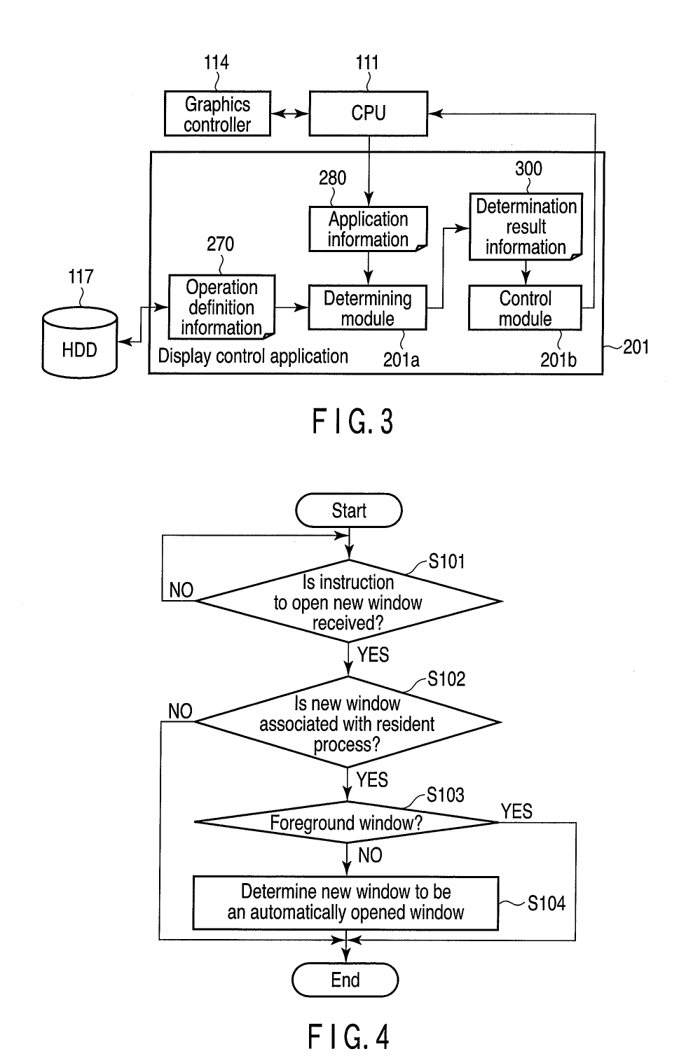

FIG. 3 is a block diagram showing the functional structure of the display control application 201.

The display control application 201 includes a determining module 201a and a control module 201b. The determining module 201a receives from the CPU 111 information 280 of an application on the desktop, which is acquired from the graphics controller 114. The information 280 of the application is, for instance, an active (focused) window opened on the desktop and the application name corresponding to this window. When the determining module 201a has received from the CPU 111a request for displaying a new window on the desktop, the determining module 201a collates the received application information 280 and operation definition information 270 corresponding to the applications pre-stored in the HDD 117. The determining module 201a transmits determination result information 300 of the collation to the control module 201b. If the collation result indicates agreement, based on the received determination result information 300, the control module 201b determines that the user is using the application corresponding to the active window.

To be more specific, the determining module 201a reads from the operation definition information 270 the operation definition information corresponding to the application name corresponding to the active window, and determines, based on the read operation definition information, whether the application corresponding to the active window is being used or not.

Thereby, the display control application 201 displays a new window on the desktop, while keeping the active state of the active window. Specifically, the new window is displayed on the desktop in an inactive state. Since the state of the active window of the application which is being used (manipulated or viewed) is maintained, the user can continue the use (manipulation or view) of the application.

FIG. 4 is a flow chart illustrating the operation of the display control method which is applied to the information processing apparatus of the embodiment. In the flow chart of FIG. 4, it is determined whether a request for a window, which is newly opened on the desktop, is a request for a window which is automatically opened. The reason for this is that if a request for a window which is newly opened by a user's instruction, and not a request for a window which is automatically opened, is received, it is desirable that the window which is opened be set in the active state.

The CPU 111 of the computer 10 loads the display control application 201, which is stored in, e.g. the HDD 117, into the main memory 112, and starts the display control application 201. The CPU 111 determines whether an instruction to open a new window has been received or not (step S101). The determination as to whether the instruction to open a new window has been received or not is executed, based on whether the CPU 111 receives an instruction to open a new window from the OS 202 or not. In step S101, if it is determined that an instruction to open a new window has been received (YES in step S101), the CPU 111 determines whether the new window is associated with a resident process or not (step S102). The CPU 111 acquires from the OS 202 a task table indicative of the information of processes which are being executed, thereby determining whether the new window is associated with a resident process or not.

For example, as shown in FIG. 5, when six processes are being executed, the information (task table) of processes which are being executed displays the correspondency between the window number and the application name with respect to each of the applications which are being executed. The applications which are being executed are, for instance, word processor software, a game, DVD player software, a USB (Universal Serial Bus) monitor process, and a download monitor process. The USB monitor process and the download monitor process are the resident processes. The USB monitor process monitors connection information which is received from the OS 202 when a USB device is connected to a USB port. For example, when a new USB memory is connected to the computer 10, a pop-up window indicating the connection of the new USB memory is displayed as a new window. This pop-up window is determined to be associated with the process of monitoring the USB port for detecting the connection of the USB device when the USB device is connected to the computer 10. A description is given of the download monitor process. In the state in which a file is being downloaded, if the download of the file is completed, a pop-up window indicating the end of the download of the file is displayed. This pop-up window is determined to be associated with the process of monitoring the process of download.

In step S102, if the CPU 111 determines that the new window is associated with the resident process (YES in step S102), the CPU 111 may determine, for example, whether the new window is a foreground window, that is, an uppermost layer window (also referred to as “uppermost window”) (step S103). The foreground window is an active (focused) window on the desktop. In step S103, if the CPU 111 determines that the new window is a foreground window, this new window corresponds to an application which is newly executed by the user's instruction, and thus the CPU 111 finishes the flow. On the other hand, in step S103, if the CPU 111 determines that the new window is not a foreground window, the CPU 111 may determine that the new window is an automatically opened window (pop-up window) (step S104). In step S102, if the CPU 111 determines that the new window is not associated with the resident process (NO in step S102), the CPU 111 may determine that the new window is not an automatically opened window (pop-up window), and may finish the flow.

By the above-described process of the flow chart, it can be determined whether the new window is an automatically opened window (pop-up window) or not.

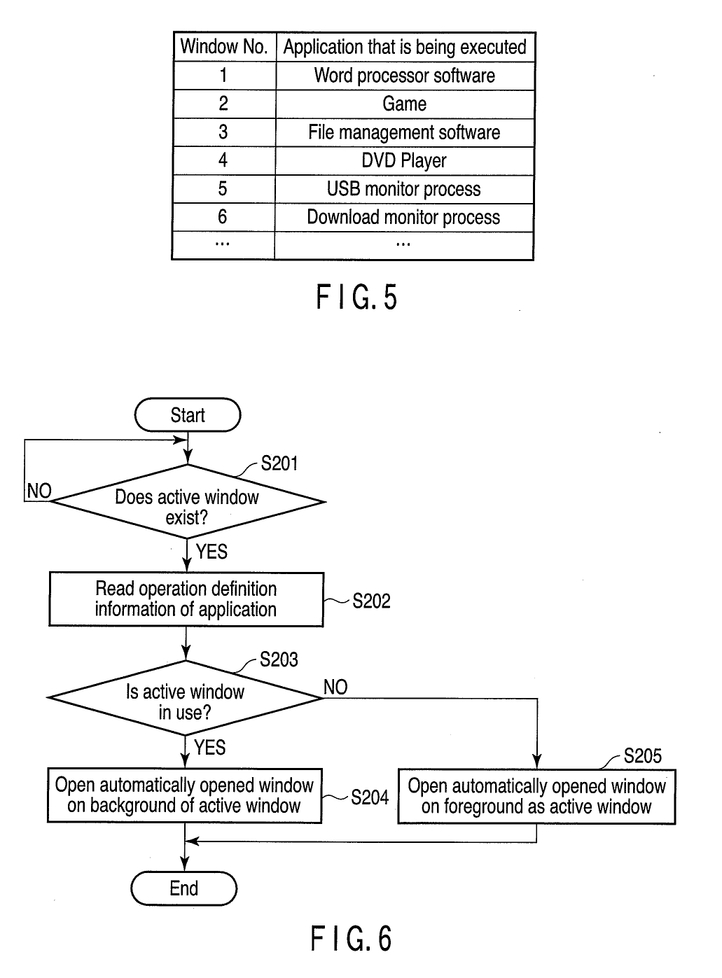

Next, referring to a flow chart of FIG. 6, a description is given of the window display process on the desktop in a case where the new window is determined to be an automatically opened window (pop-up window).

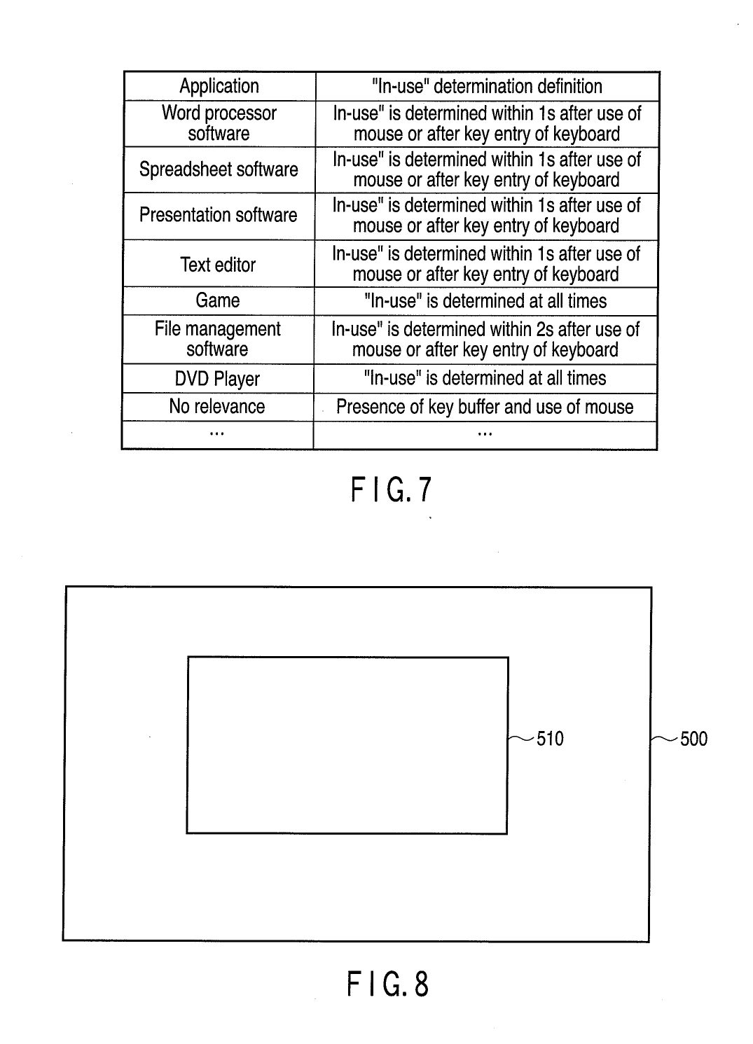

In the state in which the CPU 111 of the computer 10 is loading the display control application 201 in the main memory 112, the CPU 111 determines whether an active window exists on the desktop or not (step S201). In step S201, if the CPU 111 determines that an active window exists on the desktop (YES in step S201), the CPU 111 reads operation definition information corresponding to the application corresponding to the active window, from the plural operation definition information items 270 corresponding to the applications stored in the HDD 117 (step S202). In the operation definition information 270 of the applications, for example, as shown in FIG. 7, the operation definition for “in-use” determination is preset with respect to each of the applications. For example, as regards the word processor software, the word processor software is determined to be “in-use” during a period of is after the use of the mouse or after a key entry of the keyboard. As regards the file management software, the file management software is determined to be “in-use” during a period of 2 s after the use of the mouse or after a key entry of the keyboard.

The user often views the DVD player (predetermined application) without manipulating it for a long time. Thus, when the DVD player is being executed, the DVD player is determined to be “in-use” at all times. In the case where the operation definition information of the associated application is not included in the operation definition information 270 of applications, the application may be determined to be “in-use”, for example, when key data is present in a key buffer or the use of the mouse is enabled. Although not shown, as regards an application, such as a command prompt, which does not use the mouse, the operation of the mouse may be excluded from the conditions for determining whether the application is in use or not.

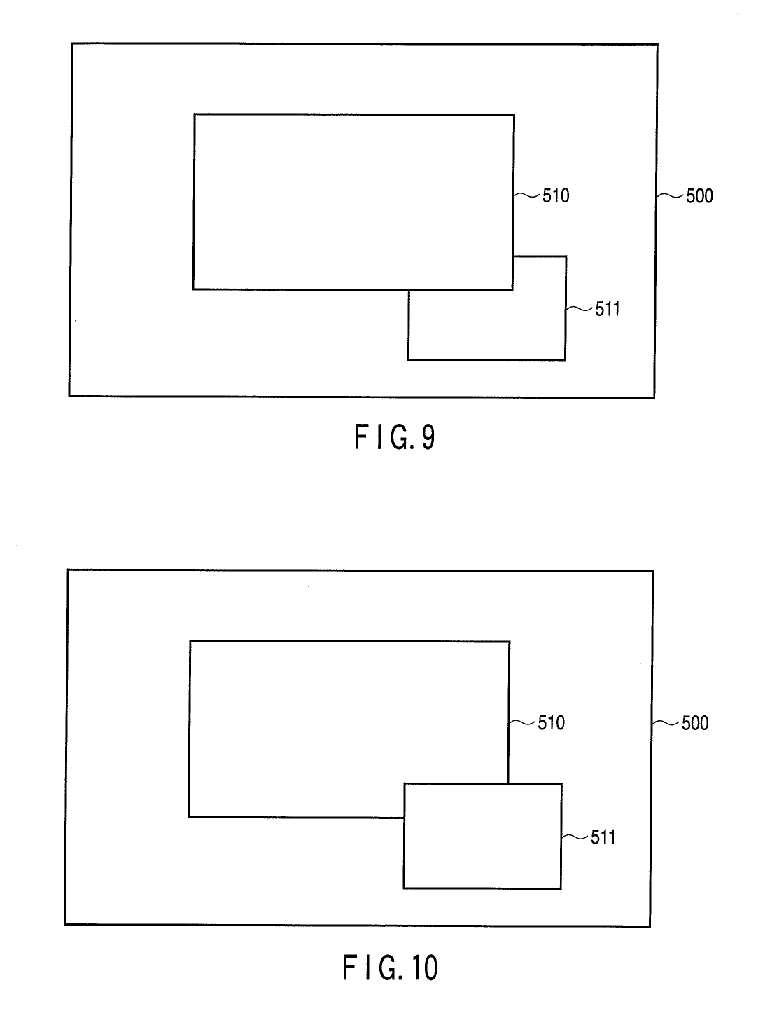

Based on the read-out operation definition information 270 of the application corresponding to the active window, the CPU 111 determines whether the active window, that is, the application corresponding to the active window, is being used or not (step S203). In step S203, if the CPU 111 determines that the application corresponding to the active window is in use (YES in step S203), the automatically opened new window is controlled to be open under the active window, that is, on the background of the active window (step S204). For example, as shown in FIG. 8, assume the case in which the CPU 111 determines that an active window 510 exists on a desktop 500. If the CPU 111 determines that the active window 510 is in use, an automatically opened window 511 is controlled to be open under the active window 510, as shown in FIG. 9. In addition, when the automatically opened new window 511 is displayed, the automatically opened new window 511 may be displayed so as not to overlap the active window 510. In this case, the CPU 111 displays the automatically opened new window 511 in the inactive state, while keeping the window 510 in the active state. Since the automatically opened new window 511 is controlled to be open under the active window 510, an icon corresponding to the new window 511 is displayed on a task bar when such a task bar exists on the desktop. However, since the new window 511 is opened under the active window, there is such a case that the user cannot recognize the new window 511. Thus, in order for the user to easily recognize the new window 511, it may be possible to produce a sound, to effect predetermined display on the desktop, or to turn on an LED or the like, which is provided on the computer 10. Furthermore, a task bar corresponding to the new window 511 may be flickered only during a predetermined time.

On the other hand, in step S203, if the CPU 111 determines that the active window is not in use, the CPU 111 executes control to open the new window as an active window on the foreground (step S205). For example, as shown in FIG. 8, assume the case in which the active window 510 exists on the desktop 500, and the active window 510 is determined to be not in use. In this case, as shown in FIG. 10, the automatically opened new window 511 is open as the active window on the foreground over the window 510. In addition, in the case of displaying the automatically opened new window 511, the automatically opened new window 511 may be displayed so as not to overlap the active window 510. In this case, the automatically opened new window 511 is displayed in the inactive state, while the window 510 is kept in the active state.

As has been described above, by using the present embodiment, whether the user is using the application corresponding to the active window can be determined according to the operation definition information which is defined with respect to each of applications. Thus, it is possible to more exactly determine whether the user is using the application corresponding to the active window. Specifically, even in the case of an application, such as a DVD player, which is viewed by the user without a manipulation for a long time, the DVD player can be determined to be in use at all times while the DVD player is being executed. It is thus possible to more exactly determine whether the application is in use or not. Moreover, a pop-up window, for instance, which is a new window that is automatically displayed on the desktop, is not displayed over the window of the application which is in use, and the usability for the user can be improved.

The above-described display control application 201 may be embedded in the OS 202 as a function of the OS 202.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to display a plurality of windows on a display, comprising:
a storage device configured to store a plurality of operation definition information items corresponding to applications which are executed on the information processing apparatus;
a determining module configured to specify an active window of windows displayed on the display, when a notice indicating that a new window is to be displayed on the display is received, and to determine whether an application corresponding to the active window is being used, based on a first operation definition information item of the plurality of operation definition information items, the first operation definition information item being associated with the application corresponding to the active window; and
a control module configured to display the new window on a background of the active window with a lower priority than the active window, when it is determined that the application corresponding to the active window is being used.

2. The information processing apparatus of claim 1, wherein the new window is a window which is automatically opened without an instruction by a user.

3. The information processing apparatus of claim 1, wherein the plurality of operation definition information items comprise operation definition information corresponding to a first predetermined application, and the operation definition information corresponding to the first predetermined application comprises a definition that the first predetermined application is in use if the first predetermined application is being executed with an active window.

4. The information processing apparatus of claim 1, wherein the plurality of operation definition information items comprise operation definition information corresponding to a second predetermined application, and the operation definition information corresponding to the second predetermined application comprises a definition that the second predetermined application is in use during a predetermined time after use of a mouse or after a key entry of a keyboard if the second predetermined application is being executed with an active window.

5. The information processing apparatus of claim 2, wherein the window which is automatically opened is associated with an application which is executed on the information processing apparatus.

6. A display control method which is used in an information processing apparatus, the information processing apparatus configured to display a plurality of windows on a display, and the information processing apparatus comprising a storage device configured to store a plurality of operation definition information items corresponding to applications which are executed on the information processing apparatus, the display control method comprising:
specifying an active window of windows displayed on the display, when a notice indicating that a new window is to be displayed on the display is received, and determining whether an application corresponding to the active window is being used, based on a first operation definition information item of the plurality of operation definition information items, the first operation definition information item being associated with the application corresponding to the active window; and
displaying the new window on a background of the active window with a lower priority than the active window, when it is determined that the application corresponding to the active window is being used.

7. The display control method of claim 6, wherein the new window is a window which is automatically opened without an instruction by a user.

8. The display control method of claim 6, wherein the plurality of operation definition information items comprise operation definition information corresponding to a first predetermined application, and the operation definition information corresponding to the first predetermined application comprises a definition that the first predetermined application is in use if the first predetermined application is being executed with an active window.

9. The display control method of claim 6, wherein the plurality of operation definition information items comprise operation definition information corresponding to a second predetermined application, and the operation definition information corresponding to the second predetermined application comprises a definition that the second predetermined application is in use during a predetermined time after use of a mouse or after a key entry of a keyboard if the second predetermined application is being executed with an active window.

10. The display control method of claim 7, wherein the window which is automatically opened is associated with an application which is executed on the information processing apparatus.
